(19) United States
(12) Patent Application Publication
(10) Pub. No.: US 2015/0150647 A1
(43) Pub. Date: Jun. 4, 2015

(54) DENTAL TOOL COMPRISING A VERSATILE TIP

(71) Applicant: NOVENDO Sarl, Paris (FR)

(72) Inventor: Eric Chevalier, Pully (CH)

(73) Assignee: NOVENDO Sarl, Paris (FR)

(21) Appl. No.: 14/412,232

(22) PCT Filed: Jul. 3, 2013
(86) PCT No.: PCT/IB2013/055451

§ 371 Date: Dec. 31, 2014

(30) Foreign Application Priority Data
Jul. 3, 2012 (CH) 1035/12

(51) Int. Cl. A61C 1/00; A61C 19/04

(52) U.S. Cl. CPC A61C 1/0015; A61C 19/04

(57) ABSTRACT

Dental tool comprising a hand piece and a head piece, the hand piece comprising a drive, a controller, a first interface and a transmitter which is connected to the controller, the head piece comprising a distal portion and a proximal portion with a second interface configured to connect the head piece to the hand piece via the first interface, the distal portion comprising a tip, which is configured to be driven by the drive, said drive being controlled by the controller. The headpiece comprises a layer whereby the layer comprises an electroresponsive material which is configured to react to a first signal from the transmitter.

The present invention relates to a dental tool comprising a hand piece and a sensing head piece and to a method of operating the dental tool.

It is known to apply a coating or a layer of material on a dental tip in order to improve certain mechanical properties of the tip (i.e. distal part of the head piece). Diamond coatings are for instance used to make tips stronger and durable for cutting and drilling treatments. Other coatings (colored mark) on tips are used for identification purposes to identify or recognize if the correct head piece is used for the operating properties adjusted on the hand piece, according standards.

U.S. Pat. No. 6,312,256 discloses a dental instrument adapted to be fixed to a hand piece. The hand piece is capable of transferring ultrasound vibrations to the dental instrument. The dental instrument comprises an active extremity which comprises concave cavities. At least one of the concave cavities comprises an opening for expelling irrigation liquid into the concave cavity. The dental instrument comprises several specially formed tips for different treatments. U.S. Pat. No. 6,312,256 does not disclose to use a coating or a sensing layer to modify properties of the dental instrument.

U.S. Pat. No. 4,283,175 discloses a powered dental scaler which comprises means for imparting vibrations on a shaft, the shaft being configured to provide vibratory movement to a work tool connected to the shaft. The work tool comprising a scaling tip, which has working surfaces provided by the edges of an elongated curved element. The curved element comprises a cross-sectional shape, for example a triangle.

For dental treatments different head pieces with different properties and shapes may be used depending on the treatment. The dental practitioner may choose the correct head piece for each application. In general the properties of operation must be adjusted for example on a controlling board, depending on the head piece mounted. This can lead to wrong operating properties for a specific head piece.

For example when an ultrasonic dental tool is used, the amplitude or the power of the ultrasound waves transmitted to the head piece by a generator depends on the type of treatment. Further the type of head piece used may differ as a function of the treatment to be performed. Consequently, for each type of dental treatment, there exist only certain families of head pieces that are suitable for operating with ultrasound waves in respective determined power and amplitude ranges. This causes room for error during use.

In order to make such appliances easier for practitioners to use, ultrasound generators may be fitted with a button or key, which makes it possible to automatically select a power range that is appropriate for the treatment. These keys may be identified by a color code enabling the practitioner to select the appropriate power range.

Nevertheless specific head pieces are also used for each treatment that are themselves intended to operate in one of the power ranges preadjusted on the appliance. Consequently, the practitioner must also verify that the head piece placed on the hand piece is well adapted to the selected power range, or he must select the power range that corresponds to the head piece mounted on the hand piece.

In order to avoid using a head piece which does not fit with the power chosen; it is known to package each head piece on a distinctive support element. The support element carries markings that match that of the power range selection keys. For example, if the keys are identified by a color code, each support element presents a color code corresponding to that of the key used for selecting the best power range for the head piece placed on the support.

An alternative solution is shown in FR 04/06630, which teaches to mark the head piece directly with a color code or the like enabling the practitioner to identify the power range for using the tip.

However, the selection of the power range on the ultrasound generator requires the intervention of the practitioner, thus complicating the use of the dental treatment appliance for the practitioner, and not eliminating the risk that the wrong power range might be selected on the generator for the specific head piece mounted.

U.S. Pat. No. 6,503,081 describes an ultrasound appliance comprising a hand piece fitted with a magnetostrictive element connected to an ultrasound generator. The ultrasound generator has processor means programmed to apply a series of signals of varying frequency to the magnetostrictive element of the hand piece carrying a head piece and to measure the consumption of the magnetostrictive element in order to detect the frequency that corresponds to the resonant frequency of the hand piece fitted with the head piece. Thereafter the processor means adjust the generator to said detected resonant frequency. However, although that document discloses a solution for detecting and adjusting the ultrasound generator on the resonant frequency of the head piece mounted on the hand piece, it does not enable the type of head piece mounted on the hand piece to be identified. Without the head piece being recognized specifically, it is not possible to adjust the generator on a power and amplitude range that is adapted to the type of head piece mounted on the hand piece.

US2008/293008 describes an ultrasound appliance comprising a surgical hand piece fitted with a transducer connected to an ultrasound generator. The hand piece is configured to receive ultrasound head pieces that are mechanically coupled to the transducer and that operate in different ultrasound wave power and amplitude ranges. The dental appliance includes means for automatically detecting the utilization power and amplitude range of the head piece mounted on the hand piece, said range extending between a lower limit and an upper limit defining respective minimum and maximum utilization power and amplitude values for the detected head piece, and processor means for automatically setting the ultrasound generator to the detected power and amplitude range.

The embodiment according to US 2008/293008 only relates to ultrasound appliances with the power and amplitude values specifically set and pre-adjusted for the detected head piece. It is not possible to adjust or optimize in real time, during the use of the head piece, the power, amplitude or even the frequency of the head piece and the transducer, respectively to achieve a better and tailored dental treatment, based on a feedback of the head piece.

The proposed recognition solution such as bar codes (simple and visual) or color codes leads to an easy copy of head pieces.

In general the mentioned prior art does not disclose to modify the properties of a head piece to better control the resistance of it and to improve the interaction with the patient's tissue, via a communication between the head piece and hand piece during the dental treatment.

An object of the present invention is to provide a dental tool, which improves the results of dental treatments and the comfort for the patient during dental treatments.

It is advantageous to provide a dental tool that reduces the risk of false manipulations prior to and during use.

It is advantageous to provide a dental tool that is economical and easy to use for the practitioner.

It is advantageous to provide a dental tool that is versatile and suitable for delicate treatments.

It is advantageous to provide a dental tool that is safe and reliable.

Objects of this invention have been achieved by providing a headpiece according to claim 1 for a dental tool or system.

Certain objects of this invention have also been achieved by a method of measuring deflection of a headpiece according to claim 12

Objects of this invention have also been achieved by a dental tool according to claim 17.

Objects of this invention have also been achieved by a method to operate a dental tool according to claim 34.

Disclosed herein is a head piece of a dental tool comprising a distal portion and a proximal portion, the proximal portion having a second interface which is configured to connect to a first interface of a hand piece of the dental tool. The head piece comprises a communication means operable to provide a piece of information in relation to the head piece to a control system, the communication means comprising an electro-responsive portion configured to generate a signal indicative of a state or condition of the headpiece.

The communication means may advantageously comprise a deflection measurement system and the piece of information comprises information in relation to the deflection of the distal end of the head piece.

In an advantageous embodiment, the electro-responsive material is configured to provide the information as a surface acoustic wave. The electro-responsive material may comprise an electrode and the signal may comprise a surface acoustic wave, which is modified and then reflected by the electrode. In variants, the electro-responsive material may be a piezoelectric material, a conductive material, a semiconductive material, an insulating material or magneto-restrictive material or combination thereof.

In an embodiment, the electro-responsive material is configured to provide the information in response to receiving a surface acoustic wave transmitted from a transmitter of the control system.

In an embodiment the deflection measurement system comprises at least a first deformation sensor and a second deformation sensor, wherein the sensors are arranged off-axis each other such that they are operable to provide information in relation to different directions of deflection of the headpiece.

Also disclosed herein is a dental system comprising the head piece connected to a hand piece via the first interface, the dental system comprising the control system which is operable to receive the piece of information from the deflection measurement system and is configured to provide the information to a user via an output means.

The output means may comprise a display means and/or audio signal which is in the audible range.

The control system and/or output means may be provided as part of the hand piece and the control system and/or output means may be operably connected to the hand piece.

In an embodiment the output means and control system are configured to indicate to the user when the deflection is exceeds a first predetermined amount and/or is less than a second predetermined amount.

The output means and control unit may be configured to communicate wirelessly.

Also disclosed herein is a method of measuring deflection of a headpiece of a dental system, the dental system comprising a dental tool having a head piece with a distal portion and a proximal portion, the proximal portion having a second interface which is to connect to a first interface of a hand piece of the dental tool, the method comprising using a deflection measurement system of the headpiece to supply information in relation to the deflection of the distal end of the headpiece to a control unit.

The method may further comprise processing the information and supplying the information to a user by means of an output means that is operatively connected to the control unit.

The method may further comprise using a transmitter of the control unit to supply a first piece of information one or more sensors of the deflection measurement system, using the or each sensors to return a second piece of information to the control unit.

In an embodiment, the electro-responsive portion or material advantageously forms an identification system and the piece of information comprises information in relation to the identification and/or operational parameters of the head piece.

The electro-responsive portion may be configured to provide the information in response to receiving a surface acoustic wave transmitted from a transmitter of the control system.

Disclosed herein is a dental tool, which comprises a drive, a controller, a hand piece and a head piece. The hand piece comprises a first interface and a transmitter which is connected to the controller. The head piece comprises a distal portion and a proximal portion with a second interface configured to connect the head piece to the hand piece via the first interface. The active headpiece comprises at least one layer, whereby the layer comprises an electroresponsive material which is configured to react to a at least a first signal from the transmitter.

The active headpiece may be configured as a drilling tip, a sensing tip, an endotontic tip or an otherwise active tip configured to decontaminate, modify and/or treat the human tissue or teeth. Active means that the headpiece is configured to react upon an input or upon an excitation.

The electroresponsive material may be configured to response with a first feedback signal to the first signal from the transmitter. The first feedback signal being received by the transmitter and processed by the controller.

It is possible, that the headpiece comprises at least one sensor which generates the first feedback signal.

The headpiece may also comprise at least one actuator which is configured to react when the headpiece receives the first signal from the transmitter.

The electroresponsive material may be a piezoelectric material, a conductive material, a semiconductive material, an insulating material or magnetorestrictive material or combination thereof.

The electroresponsive material may comprise an electrode and the signal may comprise a surface acoustic wave, which is modified and then reflected by the electrode.

It is possible that the electroresponsive material comprises a plurality of sensors, the sensors being configured to measure parameters related to the behaviour of the headpiece. The sensors may be arranged on the head piece, not directly on or within the electroresponsive material.

The head piece may comprise a first sensor, which is configured to generate a first feedback signal upon receiving the first signal. The first feedback signal may be received by the controller, which then adjusts the drive accordingly.

The sensor may be configured to continuously send feedback signals to the controller. The controller may be configured to continuously modify the signals in order to continuously adjust the drive and to generate new signals. Thus, the dental tool may comprise a feedback loop to continuously monitor properties of the head piece and the tip respectively to steer and adjust the operation of the drive in order to achieve optimal results.

The head piece may comprise an actuator, which is actuated by the sensor based on said first and second signals generated by the controller.

The feedback signals may comprise identification information and or measurement information, preferably related to motion and/or vibration and/or acoustic noise and/or strain and/or stress, from the tip. The identification information ensures for example that the right head piece for the specific dental treatment is chosen.

The controller may comprise a microprocessor to process the feedback signals from the headpiece in order to generate new signals that may be sent to the headpiece to modify properties of the electroresponsive material or to get modified feedback signals from the headpiece.

The feedback signals are used to adjust the operation properties of the drive by the controller.

The microprocessor may comprise an algorithm configured to control the modification of the feedback signals.

Disclosed herein is further a method of operating a dental tool with a hand piece and a head piece, comprising the steps of:
connecting the head piece to the hand piece;
transmitting a signal from the hand piece to the head piece to start the operation;
sensing properties by the head piece measured at the during use of the dental tool;
generating a feedback signals by the headpiece based on the measured properties; and
modifying said feedback signals in a controller of the hand piece; and
adapting the operation properties of the headpiece based on said feedback signals.

The feedback signals may be received and processed by a neural network of the controller.

Disclosed herein is further a dental tool, which comprises a hand piece and a head piece. The hand piece comprises a drive, a controller, a first interface and a transmitter which is connected to the controller. The head piece comprises a distal portion and a proximal portion with a second interface configured to connect the head piece to the hand piece via the first interface. The headpiece comprises a plasma guide portion and a microstructure electrode, whereby the microstructure electrode is configured to ignite plasma by directing electromagnetic microwaves into said plasma guide portion.

The plasma guide portion may comprise a metallic waveguide. Further the plasma guide portion may comprise a hole or a recess at least in a region where the plasma is intended to ignite.

The plasma guide portion may further comprise a two spaced apart metal layers forming an interstitial space, which is filled with at least one dielectric material.

Disclosed herein is further a functionalized head piece which comprises sensing and/or actuating material(s) such as piezoelectric material, or magnetostrictive material, or dielectric or conductive polymer, plastics or metallic material or super-elastic material or a combination thereof. The materials may be printed or deposited or coated on the substrate of the head piece in at least one thin layer. The pattern of such a thin layer may be produced by a laser etching process or by photolithography. The advantages of such processes are well known; they allow maintaining a low cost of ownership at the end of the head piece manufacturing chain. As substrate material, steel (medical grade) or plastic, or ceramics or a combination thereof may be used.

Further, at least the distal part has a specific design adapted to the particular treatment that the dentist wants to employ for his patient.

The sensing and/or actuating capabilities of the head piece allows observation, in real time, parameters about its integrity and/or its behavior during operations and/or its automatic identification by the hand piece. Thus the practitioner is able to better control the handling and treatment; the risk and pain for the patient may be diminished.

The head piece may comprise a plurality of piezoelectric thin layers deposited on portions of the substrate of the head piece; such thin layers may be used as ultrasound transducers (emitters and receivers) in order to emit ultrasound waves and receiving echoes to convert in electrical signals, to analyze and determining, advantageously in real time, the structure or morphology of a root canal, for example.

The piezoelectric thin layer deposited on a portion of the substrate of the head piece may be used to sense strains and apply specific and controlled mechanical waves through an actuator. The head piece may be used as a surface acoustic wave tag; the details are disclosed further in this document. The required energy supplied to the thin layer may be ensured and controlled by direct electric connections, such as coated electric thin layers between the head piece and its hand piece or via a wireless communication.

It is possible according to provide a thin layer comprising more than one material. Between the piezoelectric layer and the substrate a primer may be deposited to enhance the adherence of the piezoelectric thin layer on the head piece.

Disclosed herein is further a functionalized head piece which comprises sensing and/or actuating material(s) such as piezoelectric material, or magnetostrictive material, or dielectric or conductive polymer, plastics or metallic material or super-elastic material or a combination thereof. The materials can be integrated into a removable element such as a tag packaged inside the proximal part of the head piece.

Discloses herein is further an head piece recognition solution, which is used to determine if the correct head piece is used for the operation properties set on the hand piece. The recognition solution may comprise two levels:
A first level may allow to differentiate between head piece manufacturer and hand piece manufacturer to prevent counterfeit;
A second level may allow differentiating between the head piece designs or configurations leading to the adjustment of the hand piece operational modes.

The unique pattern of the thin layer(s) fixed to the head piece it is possible to send a signal from the hand piece to the head piece by electric or optical contact or wireless. The said thin layer(s) send back a unique codified feedback signal to a controller which may be integrated into the associated hand piece or may be integrated in an additional device.

Discloses herein is further an adaptive closed-loop- or open loop-controller, preferably arranged in the hand piece, that may comprise a P (proportional), PI (proportional integral), PID (proportional integral derivative), and/or fuzzy logic or genetic algorithm type. This controller and algorithm enhance the stabilization of the head piece, its performances and robustness.

Performing headpiece control operations corresponding for example to a strain-versus-revolution per second function may be implemented by using a microcontroller, which may be arranged in the controller of the hand piece.

A head piece ID (identification) feedback signal may be provided, thereby making it possible to choose from a plurality of different head pieces for a specific hand piece. The Headpiece ID feedback signal may also comprise data which allows to modify any of the respective parameters associated with the controller type used-for example the gain parameters of a PID compensator creating an adaptive controller.

The controller may continually monitor at least one head piece feature. In the case of a headpiece used with ultrasonic scaler, headpiece oscillations (amplitude and frequency) may also be sampled and compared to values fitted on a desired curve that is representative of, for example, the Impedance-versus-oscillations function for a given head piece. In the case of a head piece used with a powered hand piece, headpiece rotation speed (velocity and direction of rotation) may also be sampled and compared to values fitted on a desired curve that is representative of, for example, the strain-versus-rotation function for a given head piece. The controller may be based on any one of a variety of controller types, for example a PID compensator, which may be operated to drive the headpiece to the desired speed or oscillation.

The identification of a head piece may be done by a Surface Acoustic Wave (SAW) Identification (ID) system, which has many unbeatable merits as a security system. SAW can detect ID as well as physical properties such like temperature, pressure, strain, etc. SAW technology is used in the electronic circuitry of everyday appliance, such as mobile phones and televisions, where the waves are used to carry SAW identification information from a tag printed, for example on a piezoelectric material. SAW tags use piezoelectric crystals with “reflectors” at predetermined intervals to represent the tag's data (which can be read by variations in amplitude, time, phase and/or other variable). When the incoming radio energy is transduced to a sound wave propagating along the surface of the tag, each location reflects part of the signal back. The spacing of these reflections (or echoes) indicates the location and relative position of each reflector. The position of each reflector can then be calculated and translated into a data representation.

A reader sends an interrogation signal which is received by the tag, delayed and modified within the tag according to the stored identification information, and finally retransmitted for the reader to detect and process. More specifically, once received by the tag antenna, the interrogation signal is converted into a surface acoustic wave by an interdigital transducer (IDT). The generated wave propagates along the surface of the substrate and is partly reflected and partly transmitted at precisely positioned reflectors, consisting of narrow metal strips. Finally, the reflected train of SAW pulses carries a code based on the delays of individual reflections or, in other words, on the positions of the reflectors. The encoded acoustic signal is reconverted into electric form by the IDT and transmitted by an antenna to the reader.

SAW identification tags generally consist of two parts: firstly, an IDT, for generating and receiving SAW pulses, (or several IDTs if the tag input and output are separated) and, secondly, a means for modifying (encoding) the interrogation signal before retransmitting it. In improved geometries, the output transducers were distributed into several parallel acoustic channels. However, such multichannel geometries use more space in the transverse direction. A suggested improvement brought the encoding elements back in one common acoustic channel by replacing the encoding output IDTs with an array of chevron-type reflectors. With the slanted chevron reflectors, multiple reflections between encoding elements could be avoided. This configuration already relied on the invention of replacing the encoding transducers with acoustic wave reflectors.

Using reflectors instead of transducers enabled a more efficient use of the substrate area. The waves may make a round trip from the IDT to the reflectors and back. The same IDT may be used for both input and output. A further reduction of tag length can be obtained by folding the acoustic channel into, for example, a U-path using track-changing structures or inclined reflectors, as illustrated in the figures. The acoustic channel can be folded into a Z-path using two strongly reflecting inclined reflectors. SAW tag designs may use standard bidirectional transducers that generate wave propagation equally into the two directions perpendicular to the interdigital electrodes. For such tags, code reflectors have to be placed on both sides of the IDT. Otherwise the module will inherently have a bidirectional loss both at generation and reception of SAWs. However, arranging the reflectors on both sides of the IDT results in a relatively large tag size as free surface must be provided between the IDT and the reflectors on the two sides. A unidirectional IDT would generate wave propagation predominantly in one direction. Then all reflectors could be placed on one side of the transducer without the burden of bidirectional loss.

Disclosed herein is further, how disturbances of a periodic nature, such as those occurring in a rotating or vibrating device can be attenuated by a cancellation function. A cancellation signal may be produced by extracting one or more frequency components (harmonics) from a disturbance. A set of weighting coefficients may be generated by an artificial neural network based on information derived from the selected frequency components of the periodic disturbance signal. The artificial neural network algorithm may react, in real time, to shifts in the magnitude and phase of the disturbance frequencies selected for attenuation at the sensor location. In turn, these coefficients are applied to a function of a similar number of components and applied to the rotating headpiece. Over a period of time, feedback and adaptation will attenuate the disturbance at the selected frequencies.

A head piece fixed to a hand piece generates a disturbance of a head piece feature. A sensor made partially or completely by at least one thin layer of a electroresponsive material arranged on the headpiece may sense this disturbance and convert it into an electrical signal. Suitable sensing materials can be printed or packaged on the headpiece. A primer layer between the headpiece substrate and the sensing material can be advantageous in order to smooth the interface between the substrate and the electroresponsive material to optimize adherence between the substrate and the electroresponsive material.

The disturbance function detected by the sensor may be modulated by the frequency components at which attenuation is desired, e.g., the fundamental (i.e., .omega.), 2.omega.), and/or 3.omega.), etc. After the modulation is applied, the components corresponding to the modulation frequencies may be most prominent.

An artificial neural network, for example arranged in the hand piece, may use the output of the modulator as the input signals supplied to its input neurons. In the case where only the fundamental is considered, the network may have two input neurons; where other components are used, the network may have additional input neuron pairs for each harmonic component. If sine-cosine pairs are used, then the network will have two input neurons for each frequency. An algorithm employing back propagation will work satisfactorily, although other learning methods may be employed.

The outputs of the network may be provided to the learning algorithm. The learning algorithm compares successive values of the outputs of the network with the filtered and integrated components and then generates a delta value used to adjust the value of the weighting coefficients.

The learning or adaptation process of the artificial neural network may be facilitated by the correlation between the modulated neural network input data and the filtered component of the squared sum of the modulated disturbance signal concatenated with the temporal phase information contained in the incremental change of the network output. The weights of the artificial neural network are updated at a slow cycle processing rate with the goal of attenuating the filtered component of the modulated sensor data proportionally to the rotation rate or vibration rate of the tip. By contrast, the generation and signal processing of the modulated components occurs at the “fast” cycle processing rate.

The weighting coefficients may now be used for a cancellation signal. A cancellation signal generator applies the weighting coefficients to the frequency components of interest. This signal is supplied to an actuator, which converts the signal through a transducer to a physical disturbance applied to the headpiece. The sensor and the actuator may not necessarily be at the same position, as the attenuation will occur at the sensor.

As the artificial neural network learns, the disturbance at the frequencies of interest is attenuated until it reaches the resolution (or quantization) limits of the vibration sensor and the actuator. In a digital realization of the system, A/D (analog-to-digital) and D/A (digital-to-analog) converters could be used and their performance would also affect the degree of resolution that can be achieved.

Any perturbation in amplitude or phase of the disturbance at the frequency of modulation may result in the real-time adaptation of the weights by a proportional amount until a new steady state may be reached.

This approach is immune to disturbance at frequencies other than those selected for attenuation.

An important goal of endodontic therapy is the elimination of bacteria from the root canal. Mechanical instrumentation and chemical irrigation, in conjunction with medication of the root canal system between treatment sessions, can significantly reduce the population of bacteria inside the infected root canal. It is difficult, however, to eradicate all bacteria from the root-canal system. Consequently, the use of an atmospheric pressure cold plasma device is considered beneficial in efforts to further reduce the number of bacteria and to eradicate infection (Stefan Rupf & al. Journal of Medical Microbiology 2010, 59, 206-212).

Cleaning and sterilization of infected tissue in a dental cavity or in a root channel can be accomplished using mechanical or laser techniques. However, with both approaches, heating and destruction of healthy tissue can occur; moreover heating and vibration can seriously irritate the nerve.

Recently an alternative solution with plasma technology was disclosed in the publication R. E. J. Sladek and E. Stoffels, IEEE Trans. Plasma Sci., vol. 32, no. 4, August 2004. It comprises a tungsten wire inside a ceramic tube connected to a Radiofrequency generator (13.56 MHz) the applied voltage is typically between 200-400 Volts. A gas, Helium, flows via a gas inlet through the tube; the plasma is formed at the tip of the tungsten wire. This solution is difficult to miniaturize, is expensive and requires big radiofrequency generator.

Disclosed herein is thus a head piece integrating a metallic waveguide which allows the miniaturization of the plasma source in order to access root canals.

Disclosed herein is further a dental tool with a head piece configured to produce a plasma through microstructure electrode discharges comprising at least one guide structure, the at least one guide structure including at least one hole, whereby a plasma region includes at least one of the hole and a region adjacent to the hole. The head piece is connected to a microwave generator, the microwave generator configured to launch electromagnetic microwaves into the at least one guide structure to produce the plasma. The plasma being produced in the plasma region, whereby the at least one guide structure is an arrangement of at least two spaced metal thin layers, the at least two spaced metal thin layers forming an interstitial space filled with at least one dielectric material.

The head piece configured to produce cold plasma and a method to operate said head piece have the advantage that they require a small construction size, low power and low cost. Further the dental tool may be easier to maintain, and employs technology such as microwave generator, which are commonly used in telecommunications. Due to the slight penetration depth of currents at high frequencies, the electrode material, i.e. the guide structure (metallic waveguide or micro strip waveguide) for guiding the launched microwaves in the device producing the plasma can be kept very thin, which simplifies fabrication. Thus, at a frequency of 2.45 GHz, depending on the material used, the requisite thickness may be merely a few microns, well adapted to the dimension of a dental headpiece. Advantageously the guide structure may be coated.

A locally or spatially narrowly bounded plasma is produced by microwaves in one or preferably in a multiplicity of plasma regions that are isolated from one another, by a supplied gas or ambient air, which is directed past or through the guide structure, or which acts upon the guide structure. Thus, a gas plasma may be produced at the surface of the guide structure, at least in a region by region basis, in the plasma regions and in a plasma volume defined by these regions. The service life of the microstructure electrodes may be significantly prolonged by a protective thin layer (such as a ceramic) which may not be used in a direct voltage operation.

Moreover, to fabricate the device, one may revert to existing technologies for generating plasma and, in particular, for guiding and discharging the launched microwaves in the guide structure. Thus, advantageously the microwaves may be guided via a known waveguide hollow conductor arrangement or a known micro-strip arrangement, which is produced and structurally configured using generally known micro-structuring methods.

The microwaves generated by a microwave generator may advantageously be launched into the guide structure via at least one launching structure which communicates electrically with the guide structure. The frequency of the supplied microwaves amounts advantageously to 300 MHz to 300 GHz. As part of the device for generating the gas discharge and, respectively, the plasma, the guide structure for the injected microwaves is in an exemplary embodiment of a metallic waveguide, which is filled with dielectric material. However, in an alternative exemplary embodiment, the guide structure can be constructed of an arrangement of at least two, spaced apart metallic coatings on the tip, whose interstitial space is may be filled with a dielectric material. The waveguides, the metal thin layers of the waveguides, advantageously have a thickness, respectively a spacing that corresponds to the penetration depth of the injected microwaves.

Alternatively, the guide structure may advantageously also be an arrangement made of at least two metallic, in particular axial conductive strips, which run on a dielectric substrate. These conductive strip lines are fabricated with a thickness of a few penetration depths, preferably using known micro-structuring methods or micro-strip structuring techniques. Laser etching processing may be used to design the strip lines on the tip with a high resolution.

In addition, provision is made in the vicinity of the guide structure for at least one, but preferably for a multiplicity of, plasma regions, which are advantageously produced by a micro-structuring of the guide structure. It is quite beneficial for these plasma regions to comprise cylindrical holes in the guide structure. They are expediently distributed in a regular arrangement in the vicinity of the guide structure. In the case of a waveguide as a guide structure, these cylindrical holes have the considerable advantage that the generated electrical field is aligned within the waveguide in parallel to the cylindrical holes and is substantially homogeneous. As a result, variations in field strength in the direction of the waveguide width are minimal in comparison to higher excitable modes. To avoid or minimize surface stress or material ablation and accompanying gradual destruction of the plasma regions (i.e., of the guide structure) by the generated plasma, the inner wall of the cylindrical holes and, optionally, the entire electrode surfaces as well, are advantageously provided with a dielectric, in particular a ceramic protective thin layer. This dielectric protective thin layer only marginally degrades the propagation of the microwaves in the guide structure. The plasma is advantageously produced in the plasma-generation regions at atmospheric pressure, a microwave power of approximately 1 mW to 1 watt being advantageously supplied to the plasma regions via the microwave generator and the launching structure.

The supplied gas is preferably an inert gas, in particular argon, or might be as well as air or nitrogen. Moreover, the broad pressure range within which the work can be done, from atmospheric pressure down to a precision vacuum, makes many diverse applications possible.

The plasma headpiece in accordance with the present invention and the method implemented therewith may be especially suited for root canal treatment such as decontamination and disinfection. Its special advantage lies in the spatially narrowly limited extent of the plasma regions and in their immediate vicinity to the tissue surface to be treated.

Discloses herein is further a steerable responsive head piece, according to the definition, comprising a proximal interface and a distal elongate body. This distal elongate body is divided into a relatively rigid proximal portion that is coaxial with the interface, and a flexible distal portion capable of being deflected to an angle relative to the proximal portion. At the distal end of the head piece there is a drilling element that can penetrate a root canal, or secondary canal, or ledge, or other tissue. This drilling element is turned by a drive shaft that is operably coupled to a device operated by the dentist, for example a hand piece. Motorized steerable head pieces may also be within the scope of the invention.

The dentist can control the angle of deflection of the drilling element, the distal end of the elongate body, and the portion of the drive shaft therein, relative to that of the proximal end of the elongate body and interface. The deflection of the distal end can be controlled by turning a portion of the interface that is threadably engaged with a second portion of the interface. The rotation of these two parts of the interface separates these components, thereby increasing the overall length of the interface as well as the overall length of the device itself. This increase in the length of the device increases the tension exerted by a pull wire that is proximally affixed near the proximal portion of the interface, and distally affixed near the distal end of the elongate body. As the tension exerted by this pull wire on the flexible distal end of the elongate body increases, the distal end can be deflected, and the angle of actuation of the drilling element adjusted. The distal end of the elongate body can passively return to a coaxial configuration relative to the proximal end of the elongate body when the tension on the pull wire is reduced by rotating the interface in the other direction and thereby reducing the overall length of the interface. In some embodiments, the drive shaft is capable of a degree of axial motion so as to keep the drive shaft operably coupled with the crank, handle, interface, motor or other source of power despite the changes in the length of the interface.

A variety of adjustment controls may be used with the steerable head piece, for actuating the curvature of the distal portion of the shaft. Preferably, the adjustment control advantageously allows for one-handed operation by a dentist/practitioner. The adjustment control is a rotatable member, such as a thumb wheel or dial. The dial can be operably connected to a proximal end of an axially movable actuator such as pull wire. When the dial is rotated in a first direction, a proximally directed tension force is exerted on the pull wire, actively changing the curvature of the distal portion of the shaft as desired.

Further disclosed herein is a method of treating root canal using the steerable headpiece. In some embodiments, this method comprises the insertion of the steerable head piece through the root canal, and drilling to thoroughly clean and shape the root canals and to remove bacteria, pus and debris. The root canals may need to be shaped or hollowed out to ensure a smooth interior surface. By changing the deflection angle of the distal end of the device, multiple cavities or ledges can be drilled at different angles from a single insertion site and angle of approach. The cavity thereby created can then be filled with material such as gutta-percha or other compounds following the withdrawal of the device. It is advantageous to use a steerable head piece for ledged canals; the latter can be formed during the biomechanical preparation of the canal system, mostly in curved canals. There are two major causes for the creation of ledged canals: inadequate extension of the access opening to allow straight access to the apical part of the root canal, and using a non-curved stainless steel instrument that is too large for a curved canal. Other factors involved in ledge formation include the following: tooth type, canal location, working length, the master apical file size, the clinician's level of expertise and experience in endodontics, and root canal curvature.

Further it is within the scope of the invention to combine a head piece comprising a layer of an electroresponsive material, for example with identification tags, with a steerable distal portion or a with plasma properties. It is also possible to combine a head piece comprising plasma properties with a head piece comprising a steerable capability.

All the principles described above may combined with one another and used in one head piece or used separately in individual head pieces.

Further objects and advantageous features of the invention will be apparent from the claims, from the detailed description, and annexed drawings, in which:

FIG. 1 is a perspective view of a head piece comprising an irrigation channel of a dental tool according to the invention;

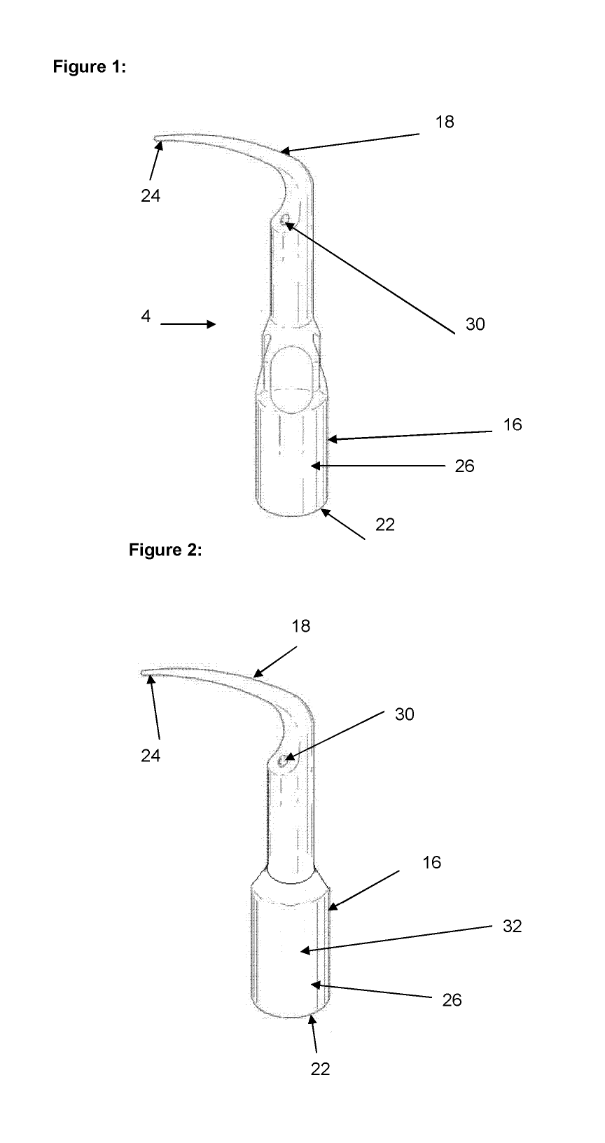

FIG. 2 is a similar perspective view as FIG. 1 of another head piece of a dental tool according of the invention;

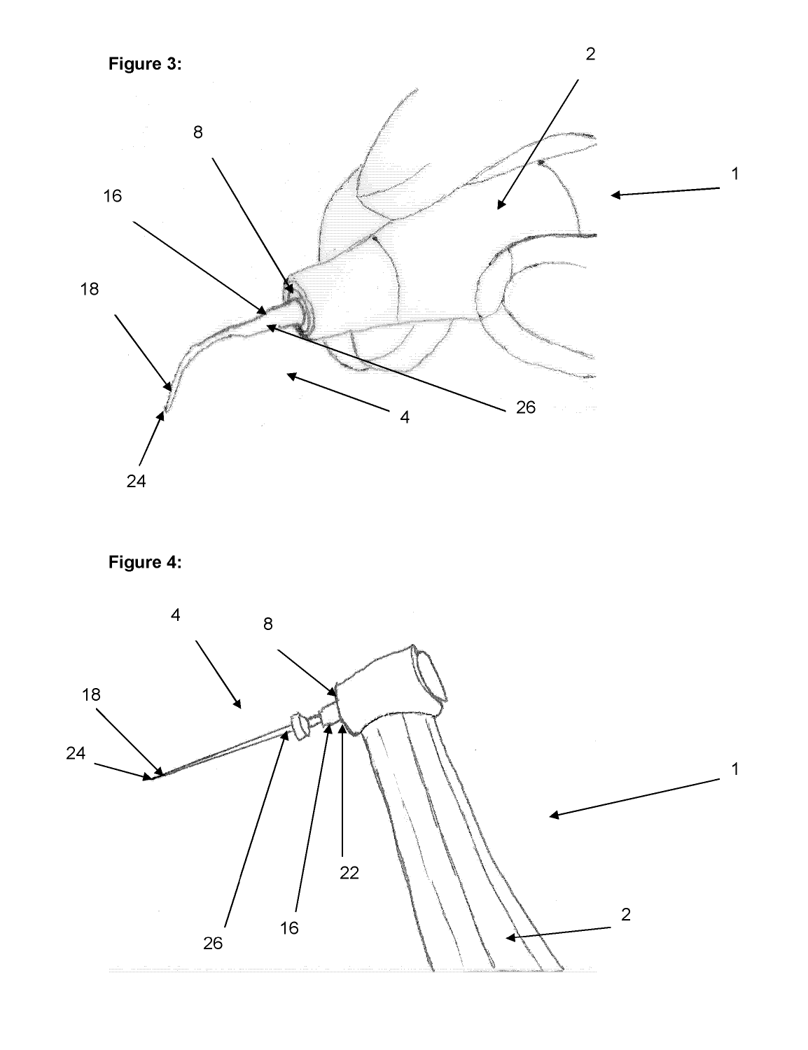

FIG. 3 is a perspective view of a dental tool according to the present invention, in the hands of a practitioner;

FIG. 4 is a perspective view of another dental tool according to the present invention;

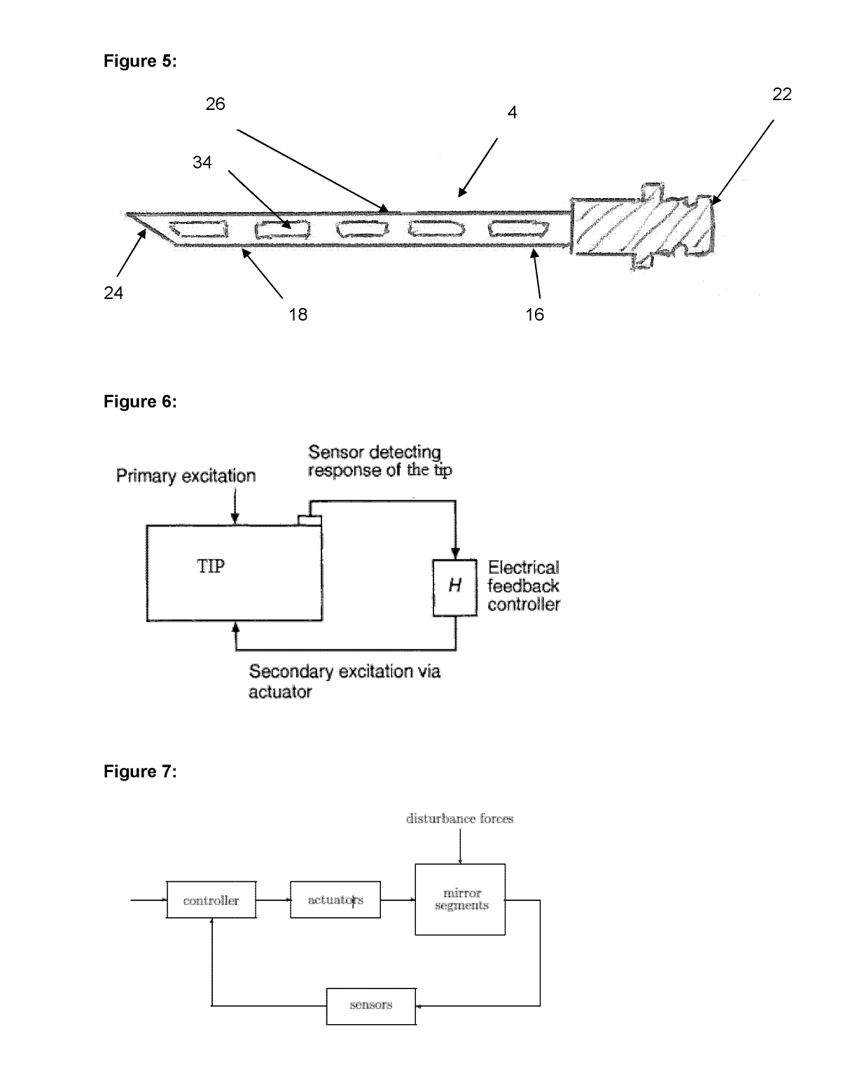

FIG. 5 is a view on a cross section of a head piece of a dental tool of the present invention comprising a hollow distal part;

FIG. 6 shows a diagram with the feedback loop between a controller and a head piece according to the present invention;

FIG. 7 shows a diagram with the feedback loop between an actuator, a controller and a sensor according to the present invention;

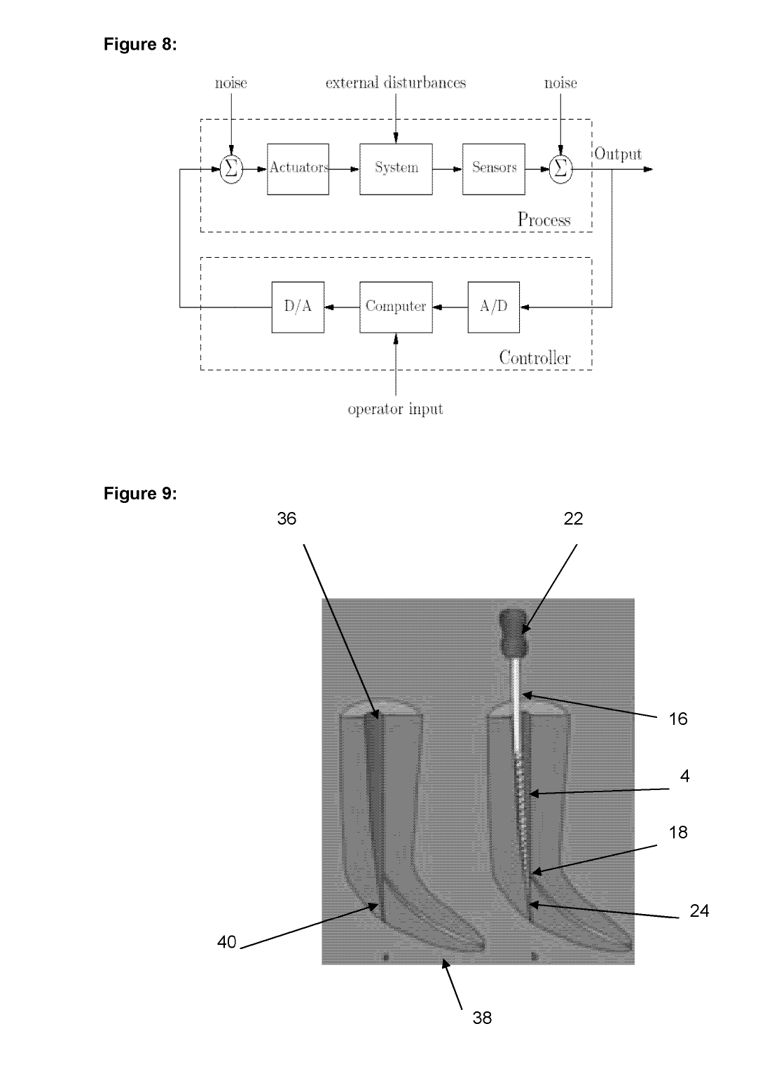

FIG. 8 shows a diagram showing the loop for controlling a head piece according to an embodiment the present invention;

FIG. 9 shows a known head piece used in a root canal of a tooth;

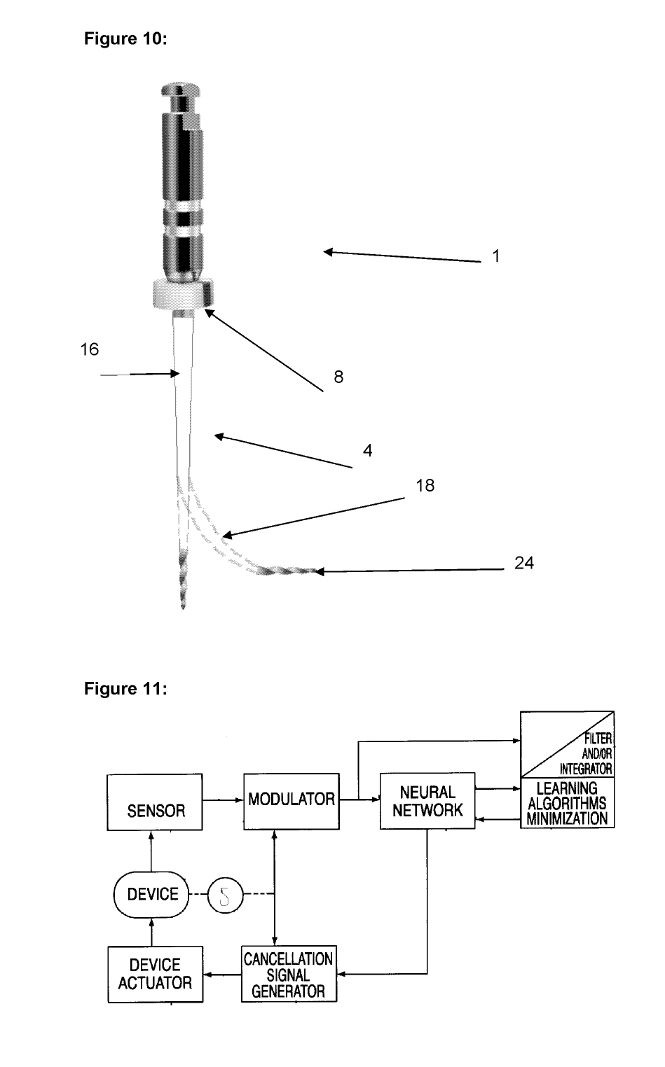

FIG. 10 is a perspective view on a dental tool comprising a steerable headpiece according to an embodiment of the invention;

FIG. 11 shows a diagram for controlling a dental tool according to the invention by using a neural network;

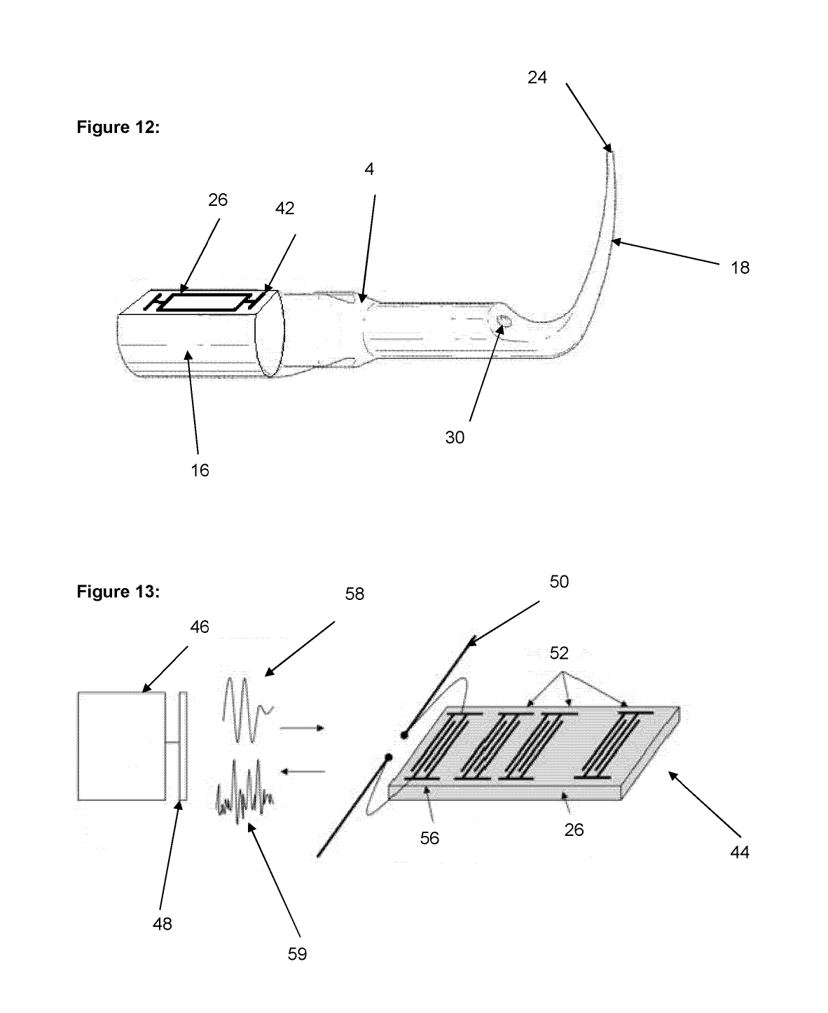

FIG. 12 shows a perspective view of a head piece with a Surface Acoustic Wave tag of a dental tool according to an embodiment of the present invention;

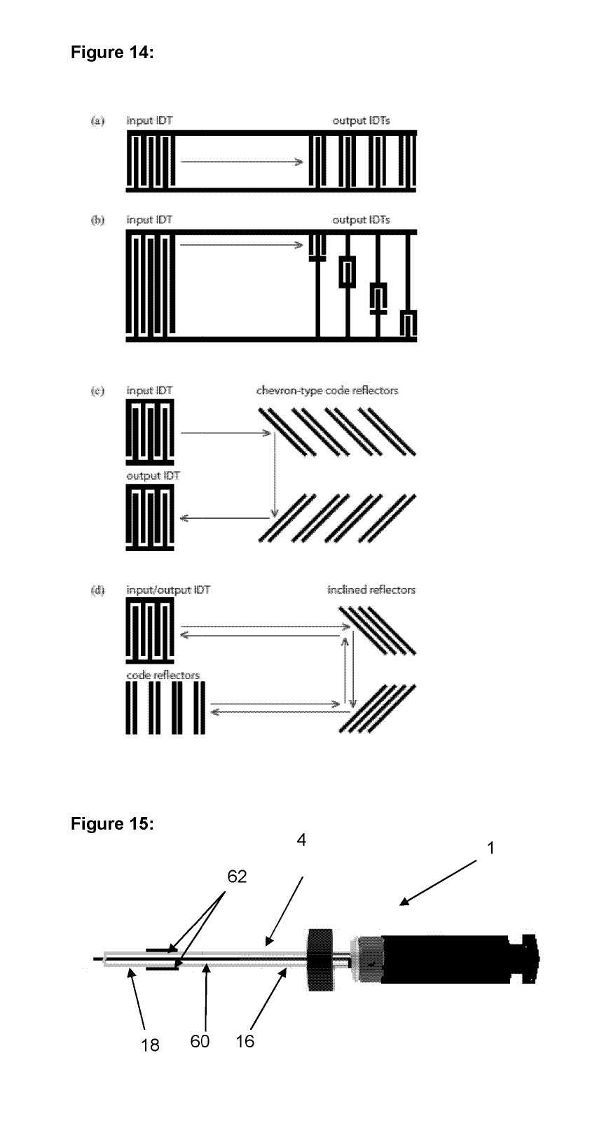

FIG. 13 shows a schematic diagram of the principle using surface acoustic wave identification;

FIG. 14 shows various examples of surface acoustic wave tags, which are configured to be used on a head piece of a dental tool according to an embodiment of the invention;

FIG. 14 shows a view on a dental tool comprising a head piece, which is configured to produce plasma according to an embodiment of the invention;

FIG. 15 shows a view of a dental tool which is configured to produce plasma according to an embodiment of the invention

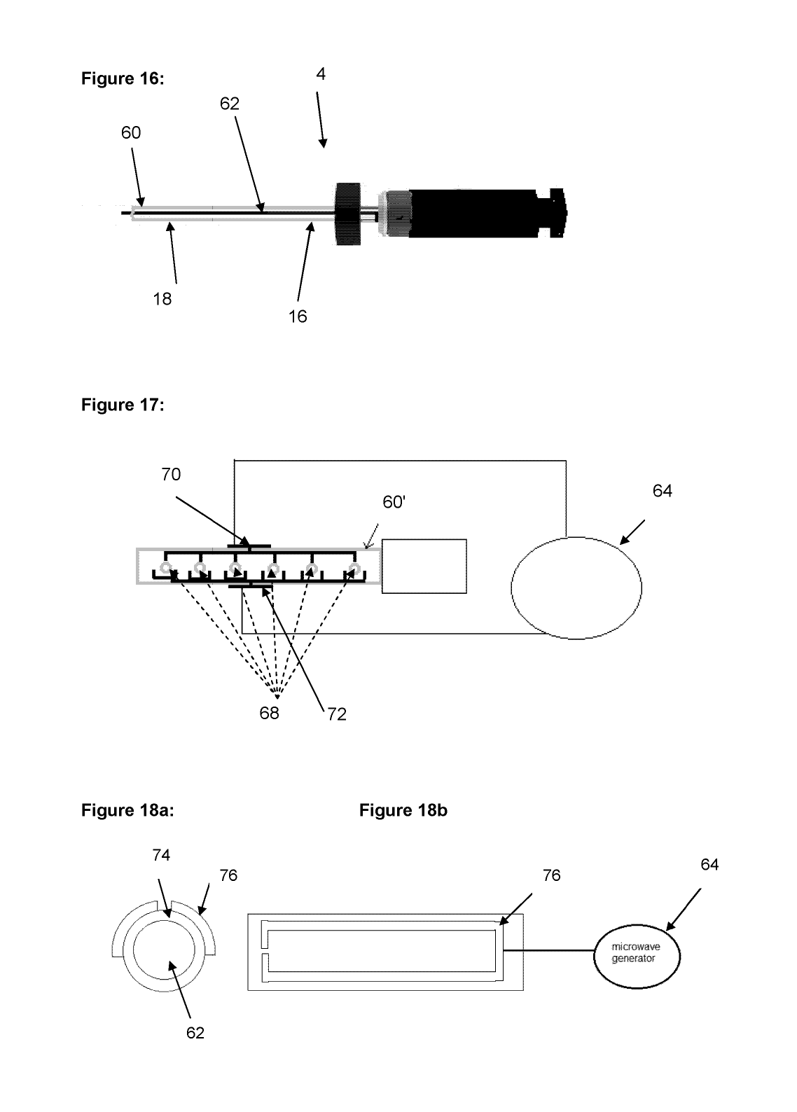

FIG. 16 shows a schematic view of a plasma igniting region on a head piece of a dental tool according to an embodiment to the invention;

FIG. 17 shows plasma guide portion which may be arranged in a head piece of a dental tool of an embodiment of the invention;

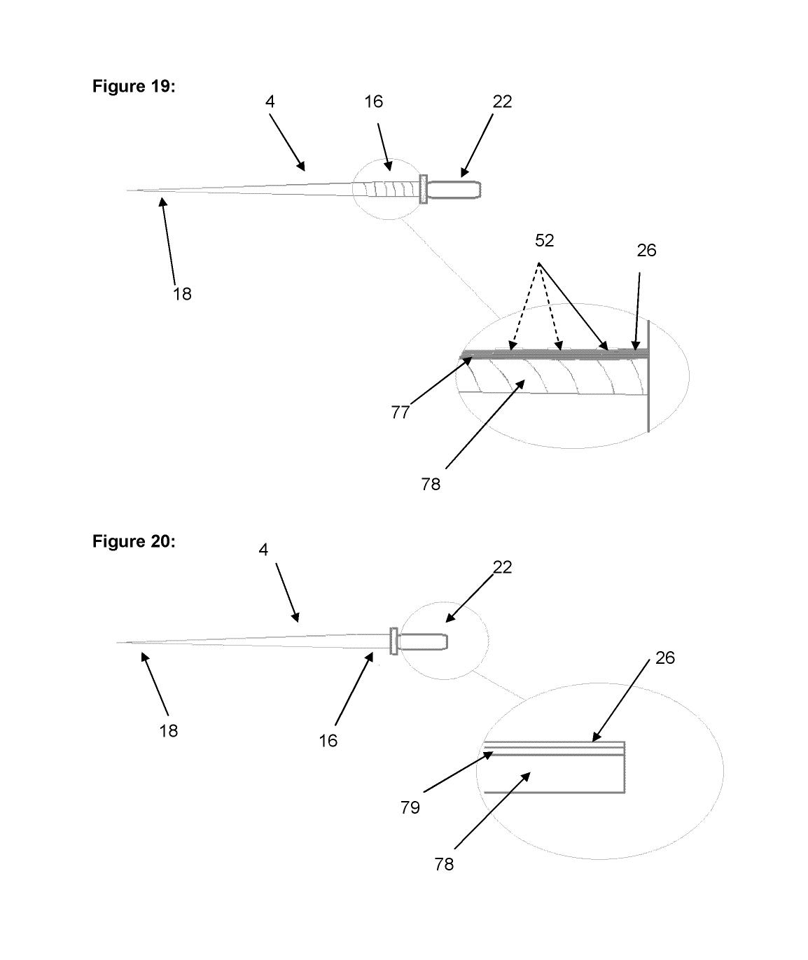

FIG. 18a shows an electrode of the plasma headpiece of a dental tool according to an embodiment of the invention;

FIG. 18b shows a plasma guide portion arranged in a plasma headpiece of dental tool according to an embodiment of the invention;

FIG. 19 shows a headpiece integrating a plurality of electroresponsive layers according to an embodiment of the invention;

FIG. 20 shows a headpiece integrating closed to the interface with a handpiece a plurality of responsive layers according to an embodiment of the invention;

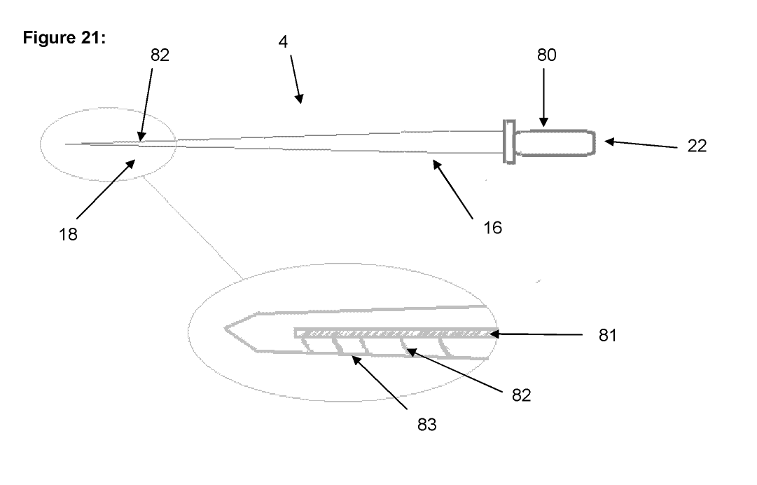

FIG. 21 shows a steerable headpiece according to an embodiment of the invention;

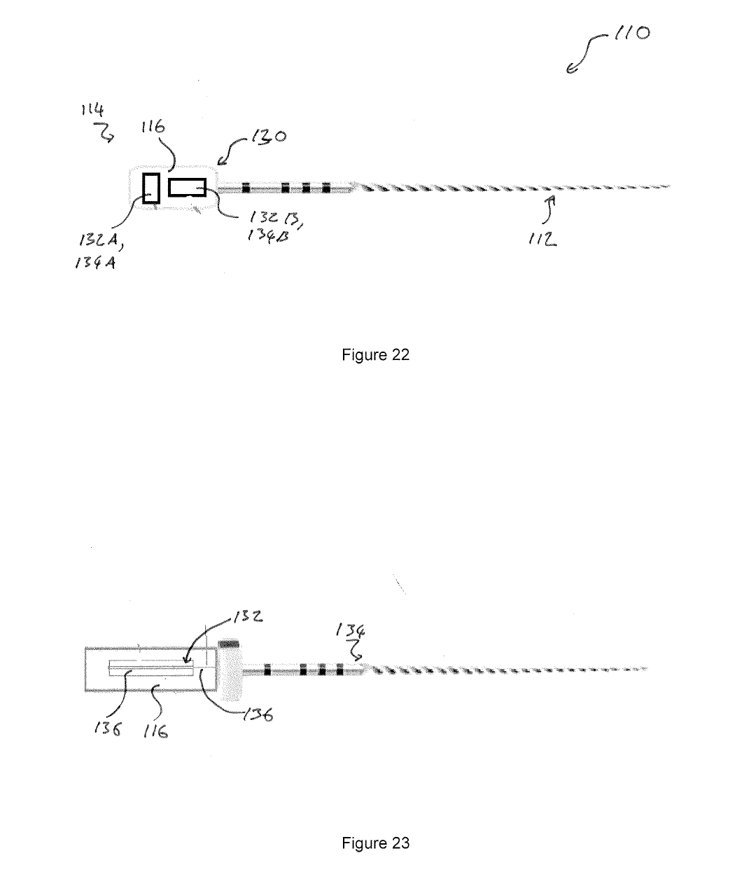

FIG. 22 shows a headpiece integrating a plurality of sensors according to an embodiment of the invention;

FIG. 23 shows a headpiece integrating a wireless sensor or tag linked to the distal part of the head piece playing the role of an antenna according to an embodiment of the invention;

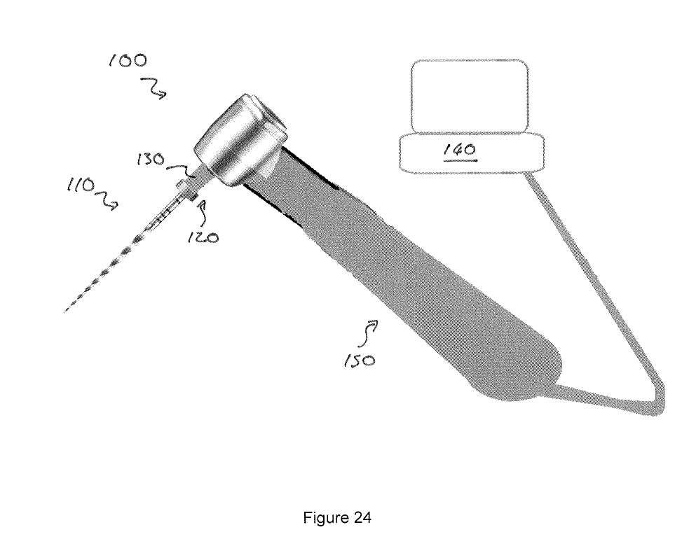

FIG. 24 is a perspective view of a dental tool according to the present invention with a sensing headpiece according to an embodiment of the invention.

FIG. 1 shows a head piece 4 of a dental tool 1. The head piece 4 comprises a proximal portion 16 and a distal portion 18. The proximal portion 16 comprises a second interface 22 and an irrigation channel 30. The irrigation channel 30 is configured to extend from the second interface 22 to the distal portion 18 so that it is able to reach a tip 24 of the distal portion 18. The second interface 22 is configured to be fixed to the hand piece 2 (not shown in these figures). The proximal portion 16 comprises a thin layer 26 of electroresponsive material [note visible in the figures].

FIG. 2 shows the head piece 4 comprising the proximal portion 16 with a movable part 32. The movable part 32 comprises the second interface 22, which is configured to engage with a first interface 8 of the hand piece 2. The hand piece 2 is indicated in FIG. 3. FIG. 3 shows the dental tool 1 and the hand piece 2 comprising a head piece 4 for dental treatments. Further a dental tool 1 according to the present invention is also shown in FIG. 4. The embodiment according to FIG. 4 may comprise a head piece configured for drilling.

FIG. 5 shows the head piece 4 which comprises a hollow substrate 34 which is intended to receive the layer 26 of electroresponsive material.

The layer 26 of electroresponsive material is able to receive and send signals for example to a controller arranged in the hand piece 2. FIG. 6 shows a diagram of a feedback loop, which is configured to be used in combination with a head piece 4 comprising at least one layer 26 of electroresponsive material deposited and or printed at the distal portion 18 and or at the proximal portion 16. The controller generates a signal which is sent to the distal portion 18 and or to the proximal portion 16 and the layer 26 of electroresponsive material, respectively, this signal may for example be sent by transmitter, the layer 26 of electro-responsive material being able to modify said signal and reflect it or sent it back to the controller as a feedback signal. The feedback signals may be used to modify and adapt operational properties of a drive. The drive may be arranged in the hand piece 2. FIG. 6 thus shows such a feedback loop which is configured to continuously monitor properties of the headpiece 4 and to adjust properties of the drive or the signals intended to be sent to the headpiece 4

FIG. 7 illustrates the feedback loop when sensors and actuators are used in a loop with a controller. Disturbance forces measured in proximity of the headpiece 4 influence the modification of the feedback signal in order to adjust the operational properties of the dental tool 1 and in order to modify or adapt the next signal sent to the sensors or actuators of the headpiece.

FIG. 8 shows another example of feedback loop and how it may be connected to a computer for analysing. The controller is also indicated in FIG. 8.

FIG. 9 show a head piece 4 engaged in a root canal 36 of a tooth 38. The tip 24 of the head piece 4 is engaged in a ledged canal 40. From this schematic view it becomes obvious, that a dental tool 1 with a steerable headpiece 4 has certain advantages when locating or treating the original root canal 36 and the ledged canal 40.

FIG. 10 shows a dental tool 1 with the head piece 4, whereby the distal portion 18 of the head piece 4 is steerable. The steerable properties may be achieved in various ways, which are described further below in this application.

FIG. 11 shows a diagram illustrating the feedback loop with a neural network. The neural network is configured to weight certain parameters and further it is configured to learn, thus it has bayesian properties.

The head piece 4 may comprise a tag 42, which is configured to be read by a surface acoustic wave system, as illustrated in FIG. 12. Any embodiment of the head piece 4 described in this application may comprise such a tag 42 in order to identify the head piece 4 and in order to verify that the right operational parameters are used to operate the dental tool 1. A surface acoustic wave system 44 comprises a reader unit 46 and a reader antenna 48 on the sender and an antenna 50, reflectors 52 an electro-responsive material 26 and an interdigital transducer 56 on the receiver's side as illustrated in FIG. 13. Between the sender and the receiver signals 58 are exchanged and partly reflected or even modified by the reflectors 52 and reflected as feedback signals 59. The feedback signals 59 have thereby a unique structure, which allows the identification of the head piece 4. The sender is preferably arranged in the hand piece 2 and the receiver on the head piece 4. Various reflector 52—and interdigital transducer 56—designs may be used to create a unique and safe feedback signal, as for example illustrated in FIG. 14.

Any of the herein described head pieces may comprise a surface acoustic wave identification system as described in the previous paragraph. A head piece 4 may be modified to carry a tag 42 for identification.

The dental tool 1 may comprise a head piece 4 with a distal portion 18, which has a channel 60 and electrodes 62 to ignite the plasma, such as illustrated in FIGS. 15 and 16. The head piece 4 may comprise a tag 42 for identification, as previously described. In the hand piece 2, linked to the head piece 4 a pulsed generator 64 is arranged. FIG. 17 shows a magnified view of a plasma ignition region comprising the generator 64 and the channel 60′ with at least six holes 68 working as gas outlets. An anode contact pad 70 and a cathode contact pad 72 are also shown in FIG. 17. The generator 64 is used to generate energy through the anode 70 and cathode 72 to ignite the plasma in the proximity of the holes.

The electrode 62 may be embedded in a dielectric material 74 for shielding purposes, such as illustrated in FIG. 18a. FIG. 18b shows a plasma guide portion 76 connected to the generator 64 which generates the microwaves. The plasma guide portion 76 may comprise a metallic waveguide portion to miniaturize the size of the igniting region of the plasma headpiece.

The FIG. 19 shows a headpiece 4 integrating at the proximal portion 16 on the headpiece substrate 78 a plurality of layers comprising electrodes 52, insulating material 77 and piezoelectric layer 26

The FIG. 20 shows a headpiece 4 integrating at the interface 22 with the handpiece on the substrate 78 a plurality of layers comprising a prime layer 79 to ensure adherence of the layer 26.

The FIG. 21 shows a steerable headpiece 4 comprising: an adjustment control 80 operably connected to pull wire 81 such as through a threaded engagement. Also shown is proximal portion 16 and distal portion 18 of a shaft 82. The distal end 18 of pull wire 81 is attached at an attachment point 82 to the distal portion 18 of shaft 82. Proximal retraction on pull wire 81 will collapse transverse slots 83 and deflect the distal portion 18 of the headpiece 4.

An embodiment of the present invention comprises a head piece 4 for dental treatment comprising a substrate made of steel, plastic or ceramic and, at least, one thin layer 26 of electroresponsive material such as piezoelectric material and/or conductive material and/or semi-conductor material and/or insulating material. The material may cover the substrate partially or completely. The layer is designed for sensing and/or actuating capabilities and/or identifying the head piece 4. The head piece 4 is mechanically fixed to a hand piece 2 comprising at least one transducer/transmitter or at least one drive.

Advantageously the head piece 4 includes electric connection means between the head piece 4 and the hand piece 2 in order to supply energy to head piece 4

The head piece 4 may include optical connection means between the head piece 4 and the hand piece 2 such as an interface between at least one optical fiber allowing lighting, or optical reading or optical detection or infrared reading.

The head piece 4 may further include fluidic connection means, for example in the shape of an irrigation channel 30, which may connected to a channel of the hand piece 2 ensuring for instance irrigation.

The head piece 4 may comprise a conductive thin layer such as an electrode coated or printed layer, arranged on at least one piezoelectric second thin layer allowing surface acoustic wave sensing capabilities of the head piece 4. It can further comprise at least one antenna 50, fixed to the headpiece and connected to at least one electrode 56 linked to the headpiece and allowing headpiece identification by the associated hand piece 2 via communication means arranged on or within the head piece 4.

The head piece may comprise a thin layer comprising ZnO or PZT material designed for at least one sensing function and/or at least one actuating function and/or configured to identify the headpiece. The said ZnO or PZT thin layer is activated either by light or by electric current/field and emits a unique identification signal 59 through at least one antenna 50 to the associated hand piece 2.

The thin layer or layers fixed to the headpiece, for example by printing metallic ink and/or hybrid ink and/or ink comprising carbon nanotubes. The hybrid ink may comprise nanoparticles to give specific functionalities.

The head piece 4 may comprise infrared identification tag 42 fixed to it for reading a code which corresponds to pre-adjusted associated hand piece 2 settings in which the said headpiece is designed to operate.

The head piece 4 may further comprise an optical reader arranged to read a code on the head piece 4 corresponding to the pre-adjusted settings of the hand piece 2 in which the head piece 4 is configured to operate. The said hand piece 2 may comprise at least one drive and at least one drive circuit, which may be connected to the controller comprising the settings.

the head piece 4 may comprise a drill, which is configured to be connected to the hand piece 2 comprising the drive, for endodontic practices.

A further embodiment of the invention relates to a method for remotely sensing properties measured on the headpiece, as described above, whereby properties of the headpiece integrity or headpiece performances are measured by using at least one passive surface acoustic wave sensing module fixed to the said headpiece. The surface acoustic wave sensing module may comprise at least one piezoelectric thin layer for measuring a headpiece feature such as strain and an antenna 50 connected to said headpiece. The antenna 50 may be configured to communicate wirelessly with a remote interrogator unit or controller, and the antenna 50 may further be configured to receive an interrogating radio frequency (RF) signal, and to transmit an RF response from the said surface acoustic wave module back to the remote interrogator unit or controller. The RF response may comprise at least an information related to the resonant frequency of the at least one piezoelectric thin layer.

The head piece 4 may further comprise at least one antenna, which is fixed to the head piece 4. Further an acoustic wave radio frequency identification portion and an acoustic wave sensor portion may be fixed to the head piece 4. The acoustic wave radio frequency identification portion may be electrically connected to the antenna 50. The acoustic wave sensor portion may also be electrically connected to the said antenna 50 and the acoustic wave radio frequency identification portion may be capable of reflecting a coded acoustic signal when an acoustic wave is generated in the acoustic wave radio frequency identification portion. The acoustic wave radio frequency identification portion may further be capable of converting the coded acoustic signal to a coded RF signal. Further the acoustic wave sensor portion may be capable of modifying a characteristic of a sensor acoustic wave, depending on a parameter which should be sensed. The acoustic wave sensor portion can be capable of generating a RF signal comprising information about the parameter, which should be sensed.

A method for providing parameter information and identification information from an acoustic wave module fixed on the head piece 4 may comprise:
generating an acoustic wave in at least a portion of the head piece;
reflecting a coded acoustic signal when the acoustic wave is generated;
converting the coded acoustic signal to a coded RF signal;
transmitting the coded RF signal from an antenna 50;
modifying a characteristic of a sensor acoustic wave in at least a portion of the head piece, depending on a parameter which should be sensed;
generating a RF signal containing information about the parameter, which should be sensed; and
transmitting the RF signal via the antenna 50.

An embodiment of the invention comprises a system for controlling the head piece 4 configured to be connected to the hand piece 2, the system comprising at least one detection circuit operable to detect a feature or properties of the head piece 4, respectively and generating at least one first feedback signal representing the feature or properties measured at the headpiece. The system may further comprise a first sensor interface configured to receive a first environmental reading from a first environmental sensor. The first sensor interface being configured to generate a second feedback signal indicative of the first environmental reading. The hand piece 2 may comprise a controller configured to receive the first feedback signal and the second feedback signal, and operable to generate a first control signal indicative of a desired feature of the headpiece according to the second feedback signal, whereby the controller is operable to generate a second control signal according to the first control signal and the first feedback signal, and to adjust the present feature of the said tip according to the second control signal.

The system configured in the second control signal may comprise a different signal from the first control signal and from the first feedback signal.

The system may further comprise a drive circuit or a transducer drive circuit linked to the hand piece 2 configured to receive the second control signal, and operable to adjust the feature of the type according to the second control signal.

The system may further comprise a second sensor interface operable to receive a second environmental reading from at least a second environmental sensor, advantageously fixed to the head piece 4. The second sensor interface configured to generate a third feedback signal indicative of the second environmental reading, whereby the controller is further configured to receive the third feedback signal, and is operable to generate the first control signal according to the second feedback signal and the third feedback signal.

The environmental sensors can be remote sensors and the environmental sensors may be embedded in the head piece 4.

The controller of the system may be configured to execute an adaptive Proportional Integral Derivative (PID) control algorithm and/or a fuzzy logic algorithm. The controller may further be configured to receive tip identification input from the headpiece. Based on this input the controller can be configured to adjust the drive, so that the headpiece 4 is operating within the correct range.

Another method for controlling at least one tip feature may comprise:
detecting and quantifying the tip feature;
generating a first feedback signal comprising information regarding the tip feature;
receiving a first environmental reading from the headpiece 4;
generating a second feedback signal based on the first environmental reading;
generating a first control signal indicative of a desired tip feature according to the second feedback signal;
generating a second control signal according to the first control signal and the first feedback signal; and
adjusting the tip feature according to the second control signal.

The method may further comprise step of generating the second control signal by subtracting the first feedback signal from the first control signal.

The method may further comprise the step of
receiving a second environmental reading;
and generating a third feedback signal corresponding to the second environmental reading;
   whereby the first control signal may be generated by using to at least the second feedback signal and the third feedback signal.

The first environmental reading may comprise a strain value and the second environmental reading comprise may comprise vibration information.

The adjustment of the tip feature may be done with the use of:
a Proportional (P) control algorithm;
a Proportional Integral (PI) control algorithm;
a PID control algorithm; or
a fuzzy logic algorithm or neural network algorithm.

The method may comprise progressively increasing or decreasing the tip feature by varying the rate at which said increasing or decreasing of the tip feature is performed based on a difference between the measured tip feature and the desired tip feature.

The method may further comprise the step of configuring one or more control parameters corresponding to respective operating characteristics of the head piece 4, whereby the second control signal is generated from the first control signal, the first feedback signal and from control parameters.

The method may comprise the step of generating the first control signal generated from the second feedback signal and from control parameters.

A further system according to an embodiment of the invention may be configured for controlling the head piece 4, comprising a controller configured to receive identification input from the headpiece 4, the controller being operable to execute a tip control algorithm and a sensor interface configured to be connected to the controller circuit and operable to receive a reading signal from a sensor fixed to the headpiece 4. The controller may be configured, upon the identification input, to adjust one or more control parameters corresponding to respective operating characteristics of the mounted head piece 4. The controller circuit may be configured to adjust a tip feature according to either one or more of:
the tip control algorithm;
the one or more control parameters; and
the reading signal.

The tip control algorithm may comprise a control algorithm based on a PID control algorithm and/or a fuzzy logic algorithm and/or a genetic algorithm.

The controller may further be configured to receive a target strain or stress or vibration input that corresponds to a desired tip feature and is configured to generate a control signal according to the strain or vibration reading in view of the target strain or stress or vibration input, whereby the controller is configured to adjust the present tip feature via the control signal.

A further embodiment of the invention relates to another system comprising the head piece 4 with the tip 24 fixed to the hand piece 2 for dental treatment. The detection circuit may be configured to detect a headpiece feature, and to generate the first feedback signal indicative of the present headpiece feature. The first sensor interface may be configured to be operable to receive the first environmental reading from the first environmental sensor fixed on the head piece 4, and to generate a second feedback signal indicative of the first environmental reading. The controller may be configured to receive the first feedback signal and the second feedback signal, and may be operable to generate the first control signal indicative of the desired tip feature according to at least the second feedback signal.

The controller can be operable to generate the second control signal according to the first control signal and the first feedback signal, and to adjust the at least one present tip feature based on the second control signal.

Another method according to an embodiment of the present invention configured to attenuate at least one disturbance in the head piece 4 connected to a hand piece 2, may comprise the steps of:
sensing the disturbance with at least one sensor;
extracting selected components of the said disturbance;
applying the selected components to an artificial neural network to generate a set of weighting coefficients;
generating a function corresponding to the selected components and employing the weighting coefficients in the function;
applying the function to the head piece 4 and/or the hand piece 2 through at least one actuator; and
adapting the weighting coefficients in response to changes sensed over time in the disturbance.

The sensor may be directly fixed to the head piece 4. The actuator may also be directly fixed to the head piece 4. The ultrasound transducer, which is arranged in the hand piece 2 may act as an actuator.

The disturbance measured may come from vibrations and/or oscillations in the region of the headpiece 4. The disturbance measured may also come from strains or stresses in the region of the headpiece 4.

Another embodiment of the present invention relates to a dental tool 1 or an apparatus configured to attenuate at least one disturbance in the headpiece 4 fixed to the hand piece. The disturbance may comprise a series of time-variable coefficients and functions and the apparatus may comprise means for detecting the disturbance in the headpiece 4 and/or said hand piece 2. The apparatus or dental tool 1 may further comprise a controller responsive to the means for detecting the disturbance in the headpiece 4 and/or said hand piece 2, in order extract one or more of the time-variable coefficients and functions from the disturbance.

The apparatus may further comprise an artificial neural network having input neurons, output neurons and a hidden neuron, the connections from the input neurons to the hidden neuron comprising a weight layer having weights, whereby the input neurons being connected to said means for detecting or extracting the disturbance in the headpiece and/or said hand piece 2. The apparatus may further comprise means providing a learning algorithm, said means being responsive to extracted parameters for adapting in real time to adjust the weights in the artificial neural network. The apparatus may further comprise a system responsive to the weights in said artificial neural network for generating a cancellation signal. The system responsive to the cancellation signal may be configured to implement at least one action to the headpiece 4 and/or hand piece 2.

Another embodiment of the present invention relates to an active headpiece 4 feature control system configured to control the tip feature resulting from at least one excitation acting upon the headpiece 4, comprising at least one actuator located at the head piece 4 configured to induce a reaction from the headpiece 4. The control system may further comprise at least one sensor producing a sensor output, the controller connected between the sensor and the actuator. The controller may comprise a system identifier for receiving the sensor output from the at least one sensor and the controller may be configured to derive a relationship between the sensor output and a reaction force induced to a structure by the at least one actuator. Further the controller may connected to the system identifier configured to receive a relationship information and for developing control driving signals out of the relationship for driving the at least one actuator. The system identifier may comprise a neural network for learning the dynamics of the headpiece 4 and may be configured to provide output signals that follow the state variables of the headpiece 4.

The active tip feature control system with a neural network may comprise a plurality of artificial neurons, each neuron receiving a weighted input from every other neuron, as well as a weighted input biasing current related to the output of the at least one sensor. The neural network configured to provide an output from each neuron to the controller.

The active headpiece feature control system may comprise a plurality of sensors. The active headpiece feature control system may comprise at least one performance sensor arranged on the head piece 4 configured to provide an output, which is indicative of the vibration, strain and/or stress sensed or measured in the region of the headpiece 4.

The active headpiece feature control system may additionally comprise at least one pseudo-feed-forward sensor located near an excitation source.

The active headpiece feature control system may comprise a neuron, which additionally includes a feedback input from itself.

The weighting of the weighted inputs to the neuron may be different for at least some of the inputs. The feedback input may also be weighted.

The invention may further comprise a method for controlling and/or attenuating motion, vibration, noise, strain or stress of the head piece 4 fixed to a hand piece 2 for dental treatment, comprising the steps of:
providing a plurality of sensors for extracting signals related to motion, vibration, acoustic noise, strain and/or stress sensed at the headpiece 4;
providing a plurality of actuators for applying controlling or attenuating motion, vibration, acoustic noise, strain and/or stress sensed at the headpiece 4;
providing the microprocessor configured to receive inputs from the sensors and to send outputs to the actuators;
operating the microprocessor with an control algorithm, preferably an intelligent, optimized algorithm; and
   the microprocessor then generating an output signal and transferring the signal to the actuators which will control tip motion, minimize and/or filter the vibration, noise, strain and/or stress induced or created around the headpiece 4.

A system of an embodiment of the present invention may be configured to control and to attenuate vibration, noise, strain and/or stress of the head piece 4 which is fixed to the hand piece 2 for dental treatment comprising a plurality of sensors attached to different parts of the head piece 4 configured to extract signals related to motion, vibration, acoustic noise, strain and/or stress sensed in the region the headpiece 4. A plurality of actuators may be attached to vibration and/or noise sources on the structure configured to emit attenuating noise and/or vibration to such sources. A microprocessor configured to receive inputs from the sensors and configured to send outputs to the actuators comprises a memory for the storage of control programs configured to be operated by the microprocessor. At least one program is arranged or stored in the memory configured to be used by the microprocessor, the program may include an optimal control program and/or a program based on an intelligent control algorithm using stored past performance information, and/or a program based on a fuzzy logic algorithm. The microprocessor may be configured to run the program and generate one or more control signals and emit such signals to the actuators to control, minimize and/or filter the motion, the vibration, noise, strain and/or stress o to the said headpiece 4.

Another embodiment of the present invention relates to a dental tool 1 comprising a plasma headpiece 24 for dental treatments. The plasma headpiece 24 is configured to produce plasma through a microstructure electrode 62 discharges. The dental tool comprises at least one plasma guide portion directly fixed on the headpiece 4, the plasma guide portion comprising at least one hole 68, whereby a plasma region includes at least one of the holes and an area adjacent to the hole. The dental tool further may comprise a microwave generator 64, the microwave generator 64 being configured to launch electromagnetic microwaves into the at least one guide structure to produce the plasma. The plasma may be produced in the plasma region, whereby the plasma guide portion may comprise at least two thin metal layers, which are spaced apart forming an interstitial space filled with at least one dielectric material.

The plasma head piece 4 may further comprise a matching element fixed to the headpiece 4 and connected to the plasma guide portion or guide structure. The microwave generator 64 may be configured to operate at a frequency of 2.45 GHz. The head piece 4 may be designed as a dental instrument configured to be connected to the hand piece 2, the head piece 4 may comprise a sonotrode and an ultrasound transducer.

The plasma head piece 4 may further comprise an interdigital transducer section, which is capable of converting an acoustic wave into an RF signal. An interdigital transducer section may partially be arranged on the head piece 4. The interdigital transducer section may comprise a plurality of metal electrodes.

The plasma head piece 4 may comprise an acoustic wave radio frequency identification portion, which may comprise a spatial pattern of metal film reflector strips fixed to the headpiece 4 with acoustic wave reflectivity capability. The spatial pattern of the strips may correlate with an identification code of the head piece 4.

The head piece comprising the plasma headpiece 4 may least partially comprise piezoelectric material; the piezoelectric material may be configured to convert vibrations or oscillations into an electric voltage difference across at least a portion of the head piece 4.

An acoustic wave sensor portion, arranged on the head piece 4, may comprise at least one sensor. The acoustic wave sensor portion may comprise an interdigital transducer section. The acoustic wave sensor portion can be configured to use different vibration modes of the interdigital transducer section to sense different tip features.

The head piece 4 may further comprise an energy capturing element, which the is configured to convert energy from an environment or a region near the headpiece 4 into energy for powering the head piece 4

A sensor acoustic wave may comprise a plurality of waves corresponding to a plurality of vibration modes of at least a portion of the head piece 4. Some of the plurality of sensor acoustic waves are thereby configured to be modified, for example by a controller.

A method according to another embodiment of the present invention comprises the steps of:
converting energy available from the environment or region near the headpiece 4 to electrical energy;
rectifying a current generated by the electrical energy;
converting the rectified current to a signal with a chosen frequency; and
using the converted signal to generate the acoustic wave.

The method may further comprise the steps of:
receiving the coded RF signal and the sensor RF signal;
extracting the parameter information from the sensor RF signal; and
extracting the identification information from the coded RF signal.

A hand piece 2 according to an embodiment of the present invention may comprise at least one transducer, which emits acoustic waves to the headpiece 4. The generated wave may propagate along the surface of the head piece 4 and is partly reflected and partly transmitted at precisely positioned reflectors 52. The reflectors 52 may comprise narrow metal strips fixed to the headpiece 4. The reflected train of surface acoustic waves pulses may carry a code based on the delays of individual reflections or, in other words, on the positions of the reflectors 52. The encoded acoustic signal may either be converted into electric form by the IDT 56 and transmitted by an antenna 50 linked to the headpiece 4 to a reader 48 or it may be detected by the transducer in the hand piece 2.

The reflectors 52 may be printed on a portion of the head piece 4.

A dental tool 1 according to an embodiment of the present invention may comprise a hand piece 2, which may transmit an electric signal to the head piece 4. The electric signal may propagate up to at least one interdigital transducer (IDT) 56 section fixed to the head piece 4, which converts it into a surface acoustic wave. The generated surface acoustic wave may partly be reflected and partly be transmitted at precisely positioned reflectors 52, comprising of narrow metal strips, fixed to the head piece 4. The reflected train of surface acoustic wave pulses may carry a code based on the delays of individual reflections or, in other words, on the positions of the reflectors 52. The encoded acoustic signal is converted into electric form by the IDT 56 and transmitted either by an antenna 50 linked to the head piece 4 to a reader or either by electric means between the head piece 4 and the hand piece 2.

The head piece 4 may comprise an automatic recognition means of the whereby the layer of electroresponsive material 26 which allows the encoding of at least one signal which is then transmitted to an optical, radiofrequency, infrared or acoustic reader 48.

The head piece 4 may comprise a closed loop controller connected to the layer 26 of electroresponsive material operating as a sensor configured to optimize and/or stabilize the corresponding tip feature during the dental treatment. The closed loop controller may be completely or partially integrated in the said hand piece 2.

The head piece 4 may further comprise active control means connected to the layer 26 of electroresponsive material configured to operate as at least one actuator to attenuate physical disturbance sensed on the tip in real time during the treatment to optimize and/or stabilize the practice. The layer 26 of electroresponsive material may be configured to be used for an acoustic filtering function employing at least one patch of piezoelectric material or magnetostrictive material.

The head piece 4 may further comprise a coil for communication purposes and/or energy purposes.

Another embodiment of the dental tool 1 according to an embodiment of the present invention comprises a steerable head piece 4 comprising an elongate tubular body having a proximal end, a distal end, and a central lumen extending therethrough. The head piece 4 further comprises a handle on the proximal end of the tubular body; the handle may comprise a deflection control system for deflecting a deflectable zone on a distal end of the tubular body. A drive shaft may be arranged in the central lumen of the tubular body. The drive shaft may include a distal portion comprising one or more slit apertures on the surface. The slit apertures may be helically shaped. Alternatively the slit apertures may comprise chevrons.

The steerable head piece 4 may comprise slit apertures comprising a screw pattern with unique size or a plurality of sizes of screw threads.

The steerable head piece 4 may comprise a wire, which is configured to be inserted via a lumen of the drive shaft and which is configured to provide radial support to the distal portion of the drive shaft comprising one more slits. The insertable wire may comprise Nitinol. The drive shaft may be configured to flex in a region comprising the slit apertures upon flexing of the deflectable zone of the tubular body.

Another embodiment of the dental tool 1 according to the present invention relates to a steerable head piece 4, which comprises an elongate tubular body having a proximal end, a distal end and a central lumen extending there through. The steerable head piece 4 may further comprise a first crimp member arranged on the distal end of the tubular body a drilling member and a second crimp member arranged on the drilling member. The second crimp member may be configured to be interlocking with the first crimp member to form a single continuous body between the tubular body and drilling member. The elongate tubular body may comprise the drive shaft. The first crimp member may comprise a plurality of raised surfaces. The second crimp member may comprise a plurality of apertures for receiving the raised surfaces.

A further embodiment of the present invention relates to a method for the treatment of a root canal 36, comprising the steps of:
inserting a steerable head piece 4 as previously described, into at least one root canal 36, or ledge 40, the steerable head piece 4 may comprise an elongate tubular body having a proximal end and a distal end, the distal end comprises a deflectable zone; and
rotating a control to deflect the deflectable zone of the steerable head piece 4 in the root canal 36 to thoroughly clean and shape the root canals and to remove bacteria, pus and debris.

The root canals may need to be shaped or hollowed out to ensure a smooth interior surface. The infection-free root canal 36 is then sealed with long-lasting barrier material such as gutta-percha and/or cement material type.

The steerable head piece 4 may further comprise fluid injection means with at least one outlet in the distal portion 18 of the steerable head piece 4, for example an irrigation channel 30. The fluid injection means may for example be used in order to ensure root canal 36 decontamination.

The steerable head piece 4 may further comprise automatic recognition means providing key information relative to the head piece 4 such as: ISO size, length, lot number, serial number, usage rate, sterilization rate, and/or optimal operating level(s). The said automatic recognition means can use RFID, Infrared identification, ultrasound identification, optical identification or a combination of these technologies for communication.

The head piece 4 may further comprise ultrasound imaging means whereby a plurality of the layers are emitters and receivers of ultrasound signals and are embedded in piezoelectric material to convert said ultrasound signals into electric signals. Thanks to ultrasound echoes generated from the interactions of the emitted ultrasound waves by said emitters and the cavity walls, and detected by the said receivers, information about the structure & morphology of the root canal may be accessible. It may also be possible to measure the length and diameter of the root canal 36.

According to a further embodiment of the invention the dental tool 100 comprises a deflection measurement system 130 which is operable to measure the deflection of the distal end 112 of the head piece 110. In use, it will be appreciated that deflection of the headpiece may occur as the head piece 110 is brought into contact with the interior of a mouth of a patient. Moreover, it will be appreciated that the deflection of the head piece can be used to measure the force applied by the headpiece to a treatment region within the mouth. It may be desirable to restrict the force such that it is below a predetermined first value, at which damage may be caused to the treatment region and/or such that the force is above a predetermined second value such that optimum treatment occurs. One such example would be during scaling and polishing.

The deflection measurement system 130 is operable to supply information in relation to the deflection to a control unit 140. The control unit 140 is operable to convey information to the user be means of an output means. The output means may comprise a display means such as a LCD screen, or other suitable graphical interface. Alternatively or additionally the output means may comprise an audio signal. For instance, the amplitude of the signal may increase with increasing deflection and/or the graphical interface may show actual or magnified deflection. Accordingly, the deflection measurement system 130 provides feedback to the control unit 140 which enables the deflection to be precisely determined and therefore controlled.

Considering the deflection measurement system 130 in more detail, in this particular embodiment it comprises, at a proximal end 114 of the head piece 110, a deformation sensor 132. In the example shown in FIG. 22 there is a first sensor 132A and second sensor 132B, however is will be appreciated that in other embodiments one or more sensors may be used.

Referring back to the example of FIG. 22, in a preferred embodiment, the sensors 132 each comprise a portion of electro responsive material 134A, B. The electro responsive material 134 is as described earlier embodiments, and is in a preferred embodiment, compatible with surface wave technology such that the propagating surface waves can be used to measure strain. It will be appreciated that in other embodiments other suitable the electro responsive material based sensors may be used. In one such example the sensors comprise strain gauges, which are operable to vary their electrical conductance in accordance with the deflection of the portion of the head piece which they are attached to.

Referring back to the preferred embodiment, the sensors 132 are mounted to the second interface 116 and are connected to to the distal part 112 of the head piece 110, for instance, by a mechanical connection. The first 132A and second 132B sensors are arranged off-axis to each other, for instance, they are normal to each other, as shown in FIG. 22. In this way they are operable to provide information in relation to different directions of deflection of the head piece.

For example, as the head piece is subject to a force that causes deflection of the distal end 112 in a first direction, the first sensor 132A is arranged to be subject to a tensile force, and when the head piece is deformed in a second direction, which is opposed to the first direction, the first sensor 132A a is subject to a compressive force. The second sensor 132B may be arranged in a similar manner, such that it is subject to tension and compression when the head piece is subject to deformation in respective third and fourth directions which are orthogonal to the first and second directions.

In this particular embodiment, the SAW sensors 132A & 132B are arranged such that their center lines are at right angles to each other. Accordingly, when one sensor is in compression, the other is in tension. Since both sensors are exposed to the same temperature, the sum of the two signals minimizes any temperature drift effects.

The sensors 132 may also be connected to a first antenna 135, which is operable to communicate with the control unit 140. In a preferred embodiment, the antenna 135 incorporated in the distal end 112 of the head piece 110, as shown in FIG. 23, and is connected to the sensors 132 by means of an electrical connection 136.

Another embodiment of the invention is provided in FIG. 23, which shows a head piece integrating a passive surface acoustic wave (SAW) tag 132. In this example the passive tag 132 is linked through an electrical connection 136 to the distal part of the head piece which functions as an antenna 135. The passive tag 132 is based on surface acoustic wave technology and can be interrogated at the distance up to 10 m with low radiated electromagnetic power of only about 10 mW. A transmitter sends an interrogation signal which supplies energy to a passive tag 132. The tag 132 is made of a piezoelectric material which converts electric energy into acoustic energy of surface acoustic wave. The sensor architecture builds a response in form of reflected acoustic signal which contains a unique identification number. This acoustic signal is converted into a radio signal which is send to the transmitter.

FIG. 24 shows a dental tool 100 comprising the sensing head piece 110, having the deflection measurement system 130 that was discussed in earlier embodiments. The head piece 110 is removably connected to a hand piece 150. In this embodiment the control unit 140 is external the hand piece 150. However, the control unit 140 may be an integral part of the hand piece 150, for instance, it is housed within the hand piece 150 or formed on the hand piece.

In a preferred embodiment the control unit 140 communicates with the deflection measurement system 130 wirelessly. For instance; the control unit 140 comprises a transceiver 142 (not shown) which is operable to supply and receive a first signal to/from a transceiver 138 (not shown) of an interface unit 136 (not shown) of the deflection measurement system 130; alternatively or additionally the transceiver 142 of the control unit 140 is operable to supply and receive a first signal to/from the electro responsive material of the deformation sensors 132, which as discussed earlier, receive the first signal, modify the first signal in accordance with the deflection characteristics of the distal end 112 and return a modified first signal.

The control unit 140 can also communicate wirelessly with the deflection control system 120 that was described in earlier embodiments by the transceiver 142 to supply and receive a second signal from a transceiver 122 (not shown) of the deflection control system 120. In an alternative embodiment communication of the control unit 140 with the deflection control system 120 and/or the defection measurement system 130 may be via an electric connection.

It will be appreciated that the electro responsive material described in earlier embodiments may be detachably connected to the head piece. For example, the tag used to identify the head piece is attached to the head piece by a detachable connection. It will be further appreciated that the various embodiments described herein may be combined. It will be further appreciated that the control unit (140) corresponds to the control of other embodiments. It will be further appreciated that the deflection system, tag, and electro responsive material of other embodiments operate as a communication means since they are able to communicate information to the control unit. It will be further appreciated that the tag to supply information to identify the head piece operates as an identification system.

1. A head piece of a dental tool comprising a distal portion and a proximal portion, the proximal portion having a second interface which is configured to connect to a first interface of a hand piece of the dental tool, wherein the head piece comprises a communication means operable to provide a piece of information in relation to the head piece to a control system, the communication means comprising an electro-responsive portion configured to generate a signal indicative of a state or condition of the headpiece, wherein the electro-responsive portion responds with a first feedback signal to a first signal from a transmitter, said first feedback signal being received by the transmitter and processed by the controller, and wherein the feedback signal comprises identification information and/or measurement information related to any one or more of motion, vibration, acoustic noise, strain and stress from the headpiece.

2. The head piece according to claim 1, wherein the communication means comprises a deflection measurement system and the piece of information comprises information in relation to the deflection of the distal end of the head piece.

3-4. (canceled)

5. The head piece according to claim 2, wherein the deflection measurement system comprises at least a first deformation sensor and a second deformation sensor, wherein the sensors are arranged off-axis from each other such that they are operable to provide information in relation to different directions of deflection of the headpiece.

6. A dental system comprising the head piece according to claim 2 which is connected to a hand piece via the first interface, the dental system comprising the control system which is operable to receive the piece of information from the deflection measurement system and is configured to provide the information to a user via an output means.

7-9. (canceled)

10. The dental system according to claim 6, wherein the output means and control system are configured to indicate to the user when the deflection is exceeds a first predetermined amount and/or is less than a second predetermined amount.

11. (canceled)

12. A method of measuring deflection of a headpiece of a dental system, the dental system comprising a dental tool having a head piece with a distal portion and a proximal portion, the proximal portion having a second interface which is to connect to a first interface of a hand piece of the dental tool, the method comprising using a deflection measurement system of the headpiece to supply information in relation to the deflection of the distal end of the headpiece to a control unit.

13-16. (canceled)

17. A dental tool comprising a controller, a hand piece and an active head piece, the hand piece comprising a first interface and the transmitter which is connected to the controller, the head piece comprising a distal portion and a proximal portion with a second interface configured to connect the head piece to the hand piece via the first interface, the active headpiece comprising a layer, characterized in that the layer comprises an electro-responsive material which is configured to react to at least a first signal from the transmitter.

18. The dental tool according to claim 17, wherein the electro-responsive material responds with a first feedback signal to the first signal from the transmitter, said first feedback signal being received by the transmitter and processed by the controller.

19. The dental tool according to claim 17, wherein the tip comprises a sensor which generates the at least first feedback signal.

20-31. (canceled)

32. The dental tool according to claim 17, wherein the controller comprises a microprocessor to process the feedback signals.

33. (canceled)

34. A method of operating the dental tool according to claim 17 with a hand piece and a head piece, comprising the steps of:
connecting the head piece to the hand piece;
transmitting a signal from the hand piece to the head piece to start the operation of the head piece;
sensing properties by the head piece measured during use of the dental tool;
generating feedback signals by the headpiece based on the measured properties; and
modifying said feedback signals in a controller of the hand piece; and
adapting the operation properties of the headpiece based on said feedback signals.

35-48. (canceled)

49. A dental tool according to claim 17 wherein the said electroresponsive material is configured to be removable from the head piece.

50. The head piece according to claim 1, wherein the electro-responsive portion forms an identification system and the piece of information comprises information in relation to the identification and/or operational parameters of the head piece.

51. The head piece according to claim 50, wherein the electro-responsive portion is configured to provide the information in response to receiving a surface acoustic wave transmitted from a transmitter of the control system.
